(19) United States
(12) Patent Application Publication
(10) Pub. No.: US 2009/0202184 A1
(43) Pub. Date: Aug. 13, 2009

(54) BUSH BEARING WITH REDUCED INSTALLATION SPACE

(75) Inventors: Tim-Malte FRANKE, Damme (DE); Torsten BALTES, Bad Essen (DE); Oliver LANGE, Damme (DE); Claudia HOPING, Lohne (DE)

Correspondence Address: NORRIS, MCLAUGHLIN & MARCUS, 875 THIRD AVE, 18TH FLOOR, NEW YORK, NY, 10022, US

(73) Assignee: ZF FRIEDRICHSHAFEN AG, Friedrichshafen (DE)

(21) Appl. No.: 12/360,175

(22) Filed: Jan. 27, 2009

(30) Foreign Application Priority Data
Feb. 8, 2008 (DE) 102008008246.5

(51) Int. Cl. F16C 27/06

(52) U.S. Cl. 384/220

(57) ABSTRACT

The elastomeric bush bearing is constructed of a metallic inner part (1) which is symmetric in relation to a bearing axis (a), an outer sleeve (3) arranged concentric with respect to the inner part (1), an elastomeric bearing body (2) arranged between the inner part (1) and the outer sleeve (3) and connected with the inner part (1) by vulcanization. At least one intermediate sheet (4) is vulcanized into the bearing body (2) which forms a support spring. The inner part (1) and the at least one intermediate sheet (4) are bulgedly expanded in a center axial region (5, 5′). The elastomeric bush bearing of the invention also has at least one longitudinal slot (6) which extends over the entire axial length and at least partially penetrates in the radial direction (r) the outer sleeve, the intermediate sheet(s) (4) and the bearing body (2) The longitudinal slot (6) is configured with respect to the bearing body (2) so as to completely penetrate the bearing body (2) as least in the region between the outer sleeve (3) and the innermost intermediate sheet (4). According to the invention, at least one axial end of the inner part (1) has an expanded outer diameter (dₐ).

### BACKGROUND OF THE INVENTION

(1) Field of the Invention

The invention relates to an elastomeric bush bearing, and a rubber bushing, respectively, which requires less installation space at the installation site than conventional bearings, while exhibiting a high radial stiffness and simultaneously a low torsional and cardanic spring rate.

(2) Description of Related Art

Elastomeric bush bearings of the type relating to the invention are employed in large numbers in the automotive industry. They are primarily used for supporting chassis components, for example for supporting the triangular control arm of a vehicle. The bearings normally consist of a rotationally symmetric, generally cylindrical and metallic inner part, an outer sleeve made of metal or plastic which is concentrically arranged around the inner part, and an elastomeric bearing body arranged between the inner part and the outer sleeve and forming a support spring, wherein the elastomeric bearing body is connected at least with the inner part by vulcanization. In some embodiments, depending on the application of the bearing and the associated requirements, intermediate sheets are inserted or vulcanized in the bearing body. When installed as intended, the bearing constructed as described above is pressed into a so-called receiving eye at the installation site.

In particular, bearings used in the automotive industry are subjected to substantial stress. They are stressed both axially and radially, but also torsionally and cardanically. The bearings must have a high radial stiffness for some applications. This is preferably achieved with a small rubber thickness of the elastomer disposed between the inner part and the outer sleeve. However, bearings which are optimized in this way for radial stiffness mostly have relatively high torsional and cardanic spring rates, so that any torsional and/or cardanic forces cause large restoring forces of the bearing body. In addition, the aforementioned design introduces unfavorable stress and strain in the component, which adversely affect the durability of the bearing.

For sake of comfort, the bearing should be constructed to provide both the required high radial stiffness as well as the smallest possible torsional and cardanic spring rate. To reduce the torsional spring rate, intermediate sheets are inserted in the bearing body in likewise concentric arrangement with respect to the inner part. It is also known to form both the inner part and the optional surrounding intermediate or insertion sheets with a bulged geometry for reducing the cardanic load or the cardanic spring rate. The inner part and the optional intermediate sheets have in a center axial region a section with an increased outer diameter. Their geometry therefore is different from a cylindrical shape. A bush bearing with a bulged inner part is described, for example, in EP 1 806 517 A1. The elastomeric bush bearing described in the aforementioned document also has two diametrically opposed slots arranged on its periphery, which extend in the radial direction through the outer sleeve, the elastomer and the interposed intermediate sheets. If such bearing, as frequently required, requires on its axial ends large contact surfaces for the counterpart at the installation site, then a bearing of the aforedescribed design requires considerable space in the vulcanization tool. The resulting bearing also has dimensions which require more space at the installation site. It is therefore necessary to increase the size of the aforementioned receiving eye, for example in a triangular control arm. As a result, the material of the control arm in this region is weakened. The latter, but also the required larger installation space itself are undesirable.

It is therefore an object of the invention to provide an elastomeric bush bearing which is configured to have a greater radial stiffness and simultaneously a smaller torsional and cardanic spring rate, while also requiring less installation space and accommodating large radial forces and large torsion angles and cardanic angles.

### BRIEF SUMMARY OF THE INVENTION

The object is attained with a bush bearing with the features of the independent claim. Advantageous embodiments and modifications of the bearing of the invention are recited in the dependent claims.

The elastomeric bush bearing proposed for attaining the object includes, as generally known, a metallic inner part which is rotationally symmetric with respect to the longitudinal axis of the bearing, an outer sleeve arranged concentrically in relation to the inner part, and an elastomeric bearing body arranged between the inner part and the outer sleeve and connected with the inner part by vulcanization. At least one intermediate sheet, which forms a support spring, is vulcanized in the bearing body. The inner part and the at least one intermediate sheet are bulgingly expanded in a center axial region of the bearing. The elastomeric bush bearing of the invention also has at least one longitudinal slot which penetrates, in the radial direction, the outer sleeve, the intermediate sheet(s) and the bearing body and extends over the entire axial length. The longitudinal slot is configured in relation to the bearing body so as to completely penetrate the bearing body at least in the region between the outer sleeve and the innermost intermediate sheet. According to the invention, the outer diameter of at least one axial end of the inner part is expanded.

With the proposed configuration of the bearing, with a bulged inner part and intermediate sheet, and with a longitudinal slot and expansion of at least one axial end, a bush bearing is realized which has a high radial stiffness due to the smallest possible rubber height (thickness of the elastomer between inner part and outer sleeve), but nevertheless has a low torsional and cardanic spring rate resulting from its special shape. Due to the expansion of at least one of its radial ends, the bearing also has a large contact surface facing the components surrounding the bearing at the installation site and operating as counter support for withstanding axial stress. Advantageously, with the longitudinal slots disposed in the bearing body, the intermediate sheet and the outer sleeve and extending over the entire axial length, a pretension can be introduced in the elastomer when the bearing is pressed into the provided receiving eye. The stress in the bearing body, in particular material-related shrinkage stress, is also reduced by the slot design. The intermediate sheet arranged in the bearing body and, as already mentioned, also constructed with a slot results in the formation of at least two mutually decoupled elastomeric layers of the bearing body in relation to the radial direction, thereby reducing its torsional spring rate. The bulged construction of the inner part and the corresponding outside contour of the intermediate sheet(s) significantly reduce the cardanic spring rate. The smaller torsional and cardanic spring rate achieved with the special shape advantageously improve the long-term operating characteristic and the service life of the bearing, accompanied by a smaller installation space.

According to a practical embodiment of the bearing, its elastomeric bearing body is at least partially or possibly completely penetrated in the radial direction by the at least one longitudinal slot in the region between the innermost intermediate sheet and the inner part. With this design, an improved and/or more uniform distribution of stress in the elastomeric can be expected.

The at least one axial end of the inner part with the enlarged outer diameter is according to a proposed embodiment flared, so that the inner diameter of the bearing is also enlarged at the respective axial end. Both axial ends of the inner part can be flared, depending on the intended application of the bearing,. Preferably, flaring is performed after vulcanization, which can prevent undercuts in the vulcanization mold that may cause problems when the component is demolded after vulcanization. The later expansion of the axial end(s) of the bush bearing makes it possible to expand the axial end(s) of a bearing having an intermediate part that concentrically surrounds the inner part and is located radially in the center, so that the outer diameter of the axial end(s) is identical to or greater than the diameter encompassed by the intermediate sheet. This makes particularly large cardanic angles feasible.

The bush bearing of the invention can also be formed with two longitudinal slots which are arranged on the bearing periphery in diametrical opposition.

The invention will now be described once more in greater detail with reference to an exemplary embodiment. The appended drawings show in:

### BRIEF DESCRIPTION OF THE SEVERAL VIEWS OF THE DRAWINGS

FIG. 1 a possible embodiment of the elastomeric bearing of the invention in a longitudinal or axial section; and

FIG. 2 the elastomeric bearing of FIG. 1 in a radial cross-section.

### DETAILED DESCRIPTION OF THE INVENTION

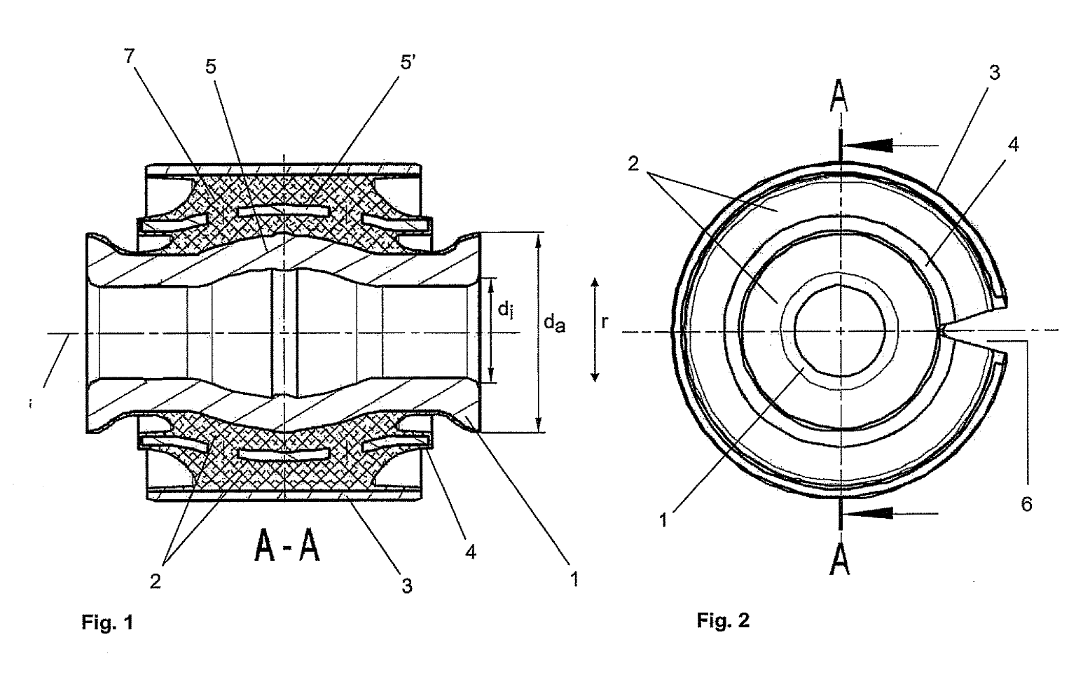

FIG. 1 illustrates a possible embodiment of the bearing of the invention in a cross-sectional view in the axial direction, i.e., parallel to the bearing axis a. The bearing is made of a metallic inner part 1, an outer sleeve 3 concentrically surrounding the inner part 1, the interposed elastomeric bearing body 2 which is joined with the inner part 1 by vulcanization, and at least one intermediate sheet 4 vulcanized in the bearing body 2.

As shown in the Figure, the inner part 1 and the surrounding intermediate sheet 4 have a bulge located in a center axial region 5, 5′. As also indicated, the outer diameter dₐ of the inner part 1 is significantly expanded at the axial ends. The intermediate sheet 4, which has a contour that substantially corresponds to that of the inner part 1, has a bulged center region 5′ and extends at its axial ends substantially parallel to the bearing axis a. For technical reasons, namely for filling the entire region between the inner part and the outer sleeve completely with the elastomer, the intermediate sheet has several openings 7, through which the elastomer flows during vulcanization. As shown in the Figure, the bearing body of the illustrated exemplary embodiment is likewise joined with the outer sleeve by vulcanization. The expanded axial ends of the inner part are flared after the vulcanization process, so that the inner diameter dᵢ is also slightly expanded in these regions.

FIG. 2 shows the bearing of FIG. 1 once more in a radial cross-section. Visible are again the inner part 1, the outer sleeve 3, the bearing body 2 and the intermediate sheet 4 vulcanized in the bearing body 2. As also shown in the Figure, the bearing has a slot 6 extending in the radial direction through the outer sleeve, the bearing body and the intermediate sheet. The slot penetrates the aforementioned parts over their entire axial extent.

### LIST OF REFERENCE SYMBOLS

1 inner part

2 bearing body

3 outer sleeve

4 intermediate sheet

5, 5′ bulged region

6 slot

7 opening

a bearing axis, axial direction

dₐ outer diameter

dᵢ inner diameter

r radial direction

1. An elastomeric bush bearing, comprising
a metallic inner part (1) which is symmetric in relation to a bearing axis (a),
an outer sleeve (3) arranged concentric with respect to an inner part (1),
an elastomeric bearing body (2) arranged between the inner part (1) and the outer sleeve (3) and connected with the inner part (1) by vulcanization, and
at least one intermediate sheet (4) arranged between the inner part (1) and the outer sleeve (3) and vulcanized into the bearing body,
wherein the inner part (1) and the at least one intermediate sheet (4) are bulgedly expanded in a center axial region (5, 5′), and the bush bearing has at least one longitudinal slot (6) which extends over the entire axial length and completely penetrates in the radial direction (r) the outer sleeve, the intermediate sheet(s) (4) and the bearing body (2) at least in a region between the outer sleeve (3) and the innermost intermediate sheet (4), and
wherein at least one of the axial ends of the inner part (1) has an expanded outer diameter (dₐ).

2. The elastomeric bush bearing according to claim 1, wherein the longitudinal slot at least partially or also completely penetrates the bearing body (2) in the region between the innermost intermediate sheet (4) and the inner part (1).

3. The elastomeric bush bearing according to claim 1, wherein the inner part (1) is flared on the at least one axial end having an expanded outer diameter (dₐ), so that its inner diameter (dᵢ) is also expanded at this axial end.

4. The elastomeric bush bearing according to claim 3, wherein an intermediate sheet (4) is arranged concentric with the inner part (1) and approximately radially at the center of the bearing body, wherein the outer diameter (dₐ) of the at least one expanded axial end of the inner part (1) is identical to or greater than the diameter encompassed by the intermediate sheet (4).

5. The elastomeric bush bearing according to claim 1, wherein the bush bearing has two opposing longitudinal slots (6) disposed on the bearing periphery.
